(19) United States
(12) Patent Application Publication
(10) Pub. No.: US 2021/0252575 A1
(43) Pub. Date: Aug. 19, 2021

(54) ARTICULATING MODULAR ROBOTIC TRIM

(71) Applicant: Magna Exteriors Inc., Concord (CA)

(72) Inventors: Paul Goegan, Concord (CA); Amin Amini, Ajax (CA); Peter Avsec, Concord (CA)

(73) Assignee: Magna Exteriors Inc., Concord (CA)

(21) Appl. No.: 17/174,798

(22) Filed: Feb. 12, 2021

Related U.S. Application Data
(60) Provisional application No. 62/976,058, filed on Feb. 13, 2020.

(51) Int. Cl. B21C 35/04; B25J 15/00; B25J 15/04; B65G 25/02

(52) U.S. Cl. CPC B21C 35/04; B65G 25/02; B25J 15/04; B25J 15/0019

(57) ABSTRACT

Articulating modular robotic trim tool system incorporating end of arm tooling with a trim die operably mounted to the ends of a plurality of robots using a specifically designed die holder. A bank of robots with trim dies operably attached to them are in operation in a production cell. A walking beam carries each extrusion that is going to be trimmed. Once the extrusion moves into position, the robots then move the trim dies onto the extrusion to complete the trim operation.

### CROSS-REFERENCE TO RELATED APPLICATIONS

This application claims the benefit of U.S. Provisional Application No. 62/976,058, filed Feb. 13, 2020. The disclosures of the above application are incorporated herein by reference.

### FIELD OF THE INVENTION

The present invention relates to an articulating modular robotic trim system and method of manufacture.

### BACKGROUND OF THE INVENTION

In the production of parts, trimming operations are traditionally done by using a sequence of trim presses and operators manually loading the extrusion onto a horn. Once this step is complete, the operator activates the press and completes the operation. This is time and labor intensive. One problem is being able to maintain a competitive advantage such as through the reduction of labor required to produce the parts, e.g., belts, etc. parts for vehicles).

Other products attempt to solve the above-described problems through incorporating cylinders actuating a die-set by travelling along a linear rail. The cutting mechanism is then driven into the part with additional cylinders. This method is a more cost-effective approach and reduces the amount of labor, however it does not accommodate any deviation of sweep or bend on the part. It also does not comply with the advantageous SMED strategy (single minute exchange of die) and must be dedicated to specific part types/customers.

Accordingly, there exists a need for a system that reduces labor content to the trimming operation by utilizing robots where traditionally this has been done with manual labor. In addition, reduced changeover time by implementing single minute exchange of die (“SMED”) strategy. This also provides the ability to redeploy the capital investment saved for future products/business.

### SUMMARY OF THE INVENTION

In accordance with aspects of the present invention, variation in the extrusion cross sections of parts is overcome by mounting an interchangeable trim tool on a multi-axis robot with quick change capability. The present invention has several advantages, including that the changeover time has been reduced, e.g., by at least about 4 hours daily. The investment in the asset can easily be redeployed for future programs.

In accordance with aspects of the present invention, the predetermined extrusion is held securely in position. The present invention also provides the ability to retool the automation easily for future business/products, and to change the sequence of operations or change/add tooling components, as desired. The present invention also allows reduced labor content to maintain a competitive advantage.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a front perspective view of an exemplary end of arm tooling, in accordance with the present invention;

FIG. 2 is a rear perspective view of the end of arm tooling;

FIG. 3 is a front elevation view of the end of arm tooling;

FIG. 4 is a top plan view of the end of arm tooling;

FIG. 5 is a side elevation view of the end of arm tooling;

FIG. 6 is a top plan view of an exemplary production cell incorporating articulating modular robotic end of arm tooling, in accordance with the present invention;

FIG. 7 is a perspective view of exemplary trim dies mounted to robots in an exemplary production system, in accordance with aspects of the present invention;

FIG. 8 is a perspective view of the production system, with a product advanced to at least one robot for processing, in accordance with the present invention;

FIG. 9 is a perspective view of the production system;

FIG. 10 is a perspective view of the production system, with a plurality of products advanced to a plurality of robots for predetermined processing, in accordance with the present invention;

FIG. 11 is a perspective view of the production system, with a plurality of products advanced further for predetermined processing, in accordance with the present invention; and

FIG. 12 is a perspective view of the production system.

### DETAILED DESCRIPTION OF THE PREFERRED EMBODIMENTS

The following description of the preferred embodiment(s) is merely exemplary in nature and is in no way intended to limit the invention, its application, or uses.

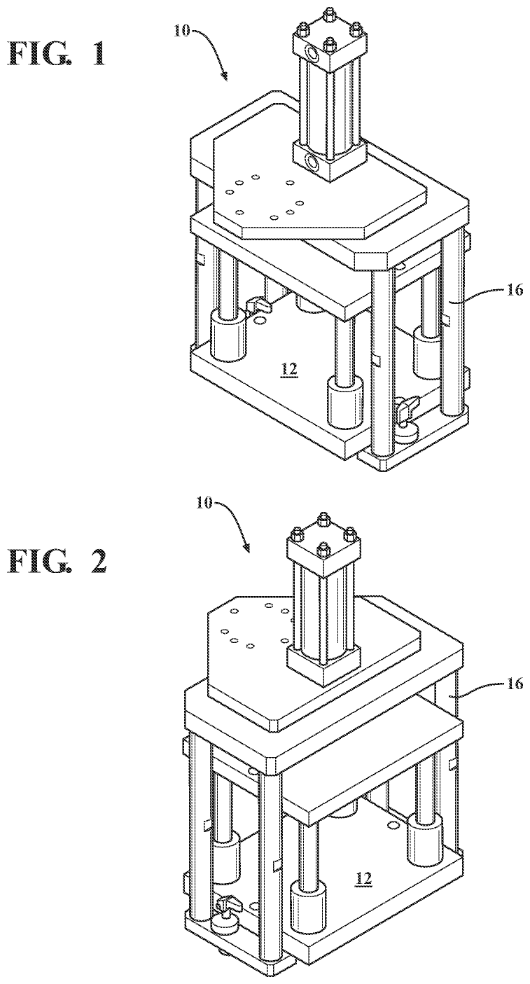

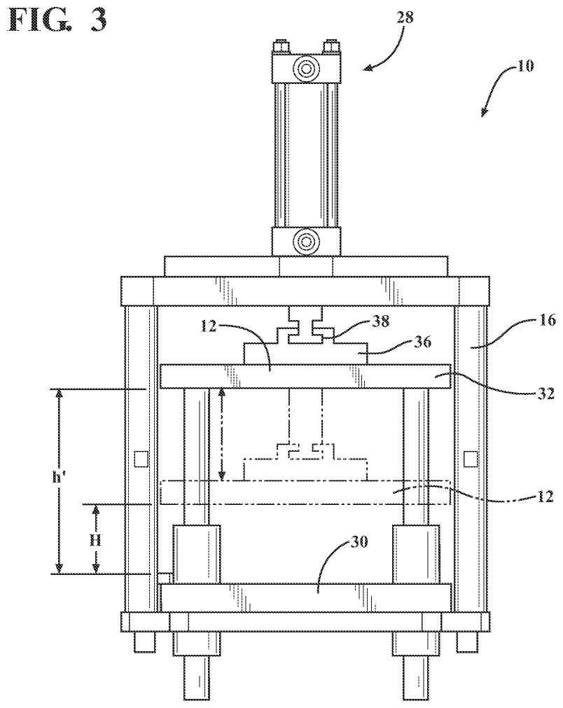

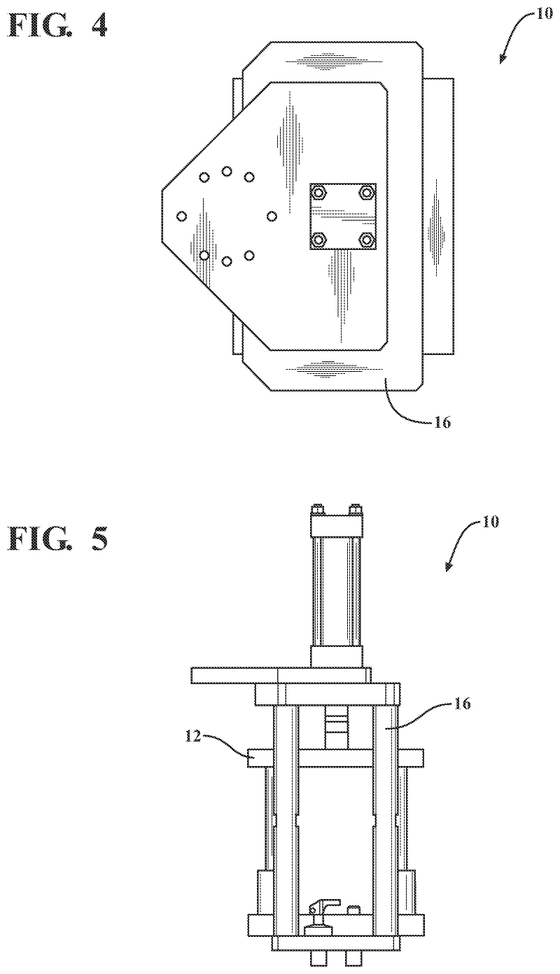

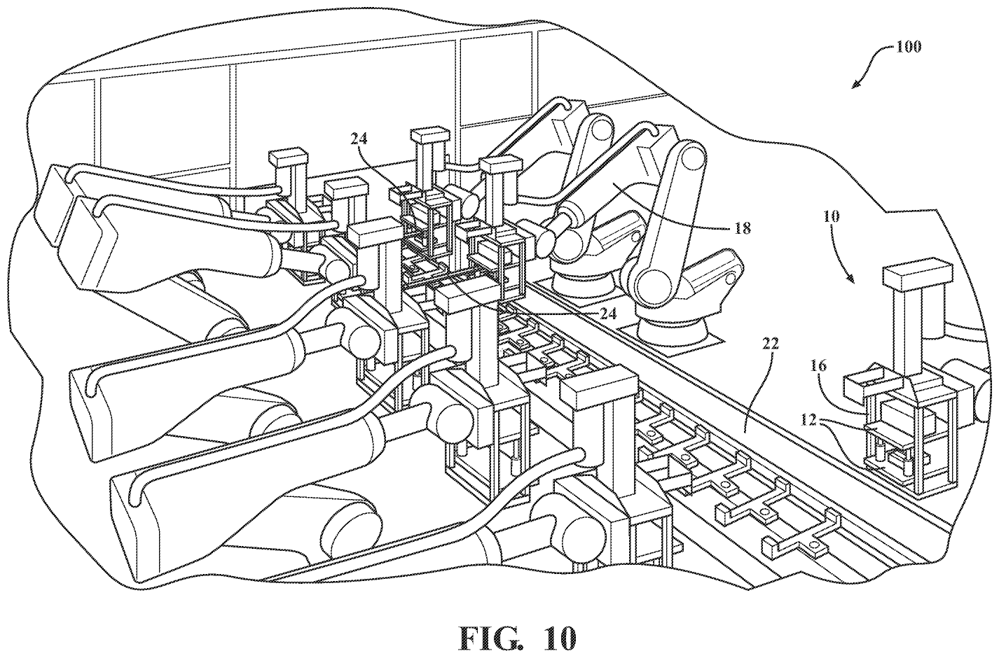

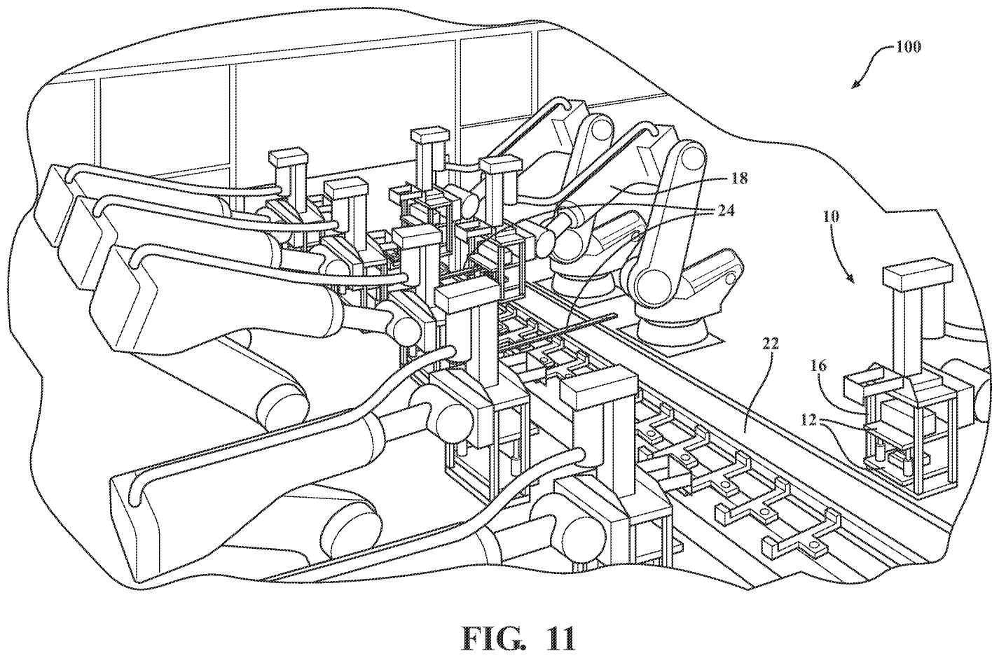

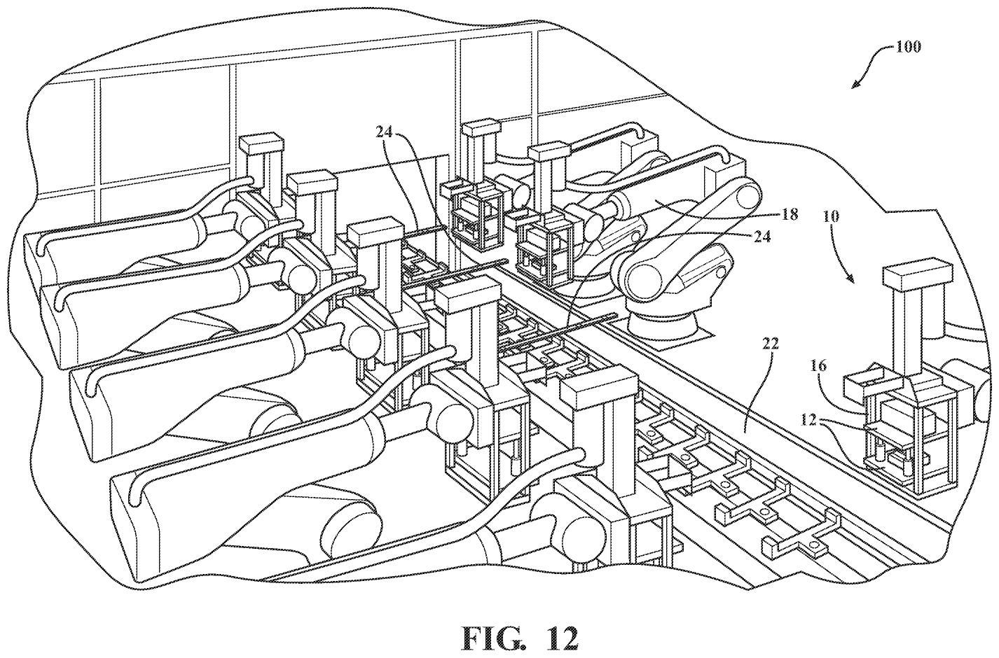

Referring to FIG. 1-12 generally, there is provided an articulating modular trim system including end of arm tooling (EOAT) and robots. There is provided at least one end of arm tool shown generally at 10 including a trim die portion 12 that is articulatable (e.g., see FIG. 3 solid line and in phantom). The EOAT 10 is selectively operably mounted to at least one robot 14 using a specifically designed die holder 16 that includes at least one attachment portion shown generally at 28 to operably secure the EOAT 10 to an arm 18 of the robot 14. The die holder 16 is operably incorporated with the end of arm tooling 10 and operably connects to the end of the robot 14, e.g., with a plurality of fasteners, etc.). The die holder 16 is operably adapted for predetermined applications to operably carry any trim die portion 12 adapted for a plurality of different products.

Preferably, a plurality of end of arm tools 10 are provided adapted to operably process parts in at least one predetermined process, e.g., to trim, cut, pierce clip, press, punch apertures, form at least one predetermined feature, punch shapes, punch, etc. Depending on the application, the end of arm tooling 10 is selectively operably detached from the robot 14 and another end of arm tool 10, which is adapted for a particular application (e.g., for a different shaped trim die for a second product), is then operably attached to that robot 14. This provides quick changeover capability and cost and time saving production system flexibility to accommodate and process any predetermined products

Referring generally to FIGS. 1-12, and more particularly to FIGS. 1-5, there is depicted exemplary end of arm tooling 10 (EOAT) operable for selectively attaching to the robot arm 18 and operable to accept at least one trim die portion 12 (e.g., ball bearing die set, internal gussets, die plates, etc.). Preferably, at least one predetermined die trim indicated generally at 34 is operably connected to the trim die portion 12 (e.g., 2-piece die trim, upper and lower die trim, a part holder and a part cutter, cutter portion and moveable plate, cut device, die shoe(s), etc.). Preferably, when an extrusion 24 to be processed is operably aligned in the EOAT 10, a first portion 30 of the die press portion 12 remains fixed (e.g., bottom portion) while a second portion 32 of the die press portion 12 (e.g., top portion) is operably moved toward the first portion 30 (e.g., utilizing at least two guideposts, bearings, etc.). By way of non-limiting example, FIG. 3 depicts an exemplary open height ‘h” and exemplary shut height ‘H”. Depending on the particular predetermined process, the die trim 34 operably cuts, or otherwise operably processes, the extrusion 24, when the die trim portion 12 is at a predetermined shut height. Typically, a predetermined press force is applied, e.g., at least about 2 to 3 tons.

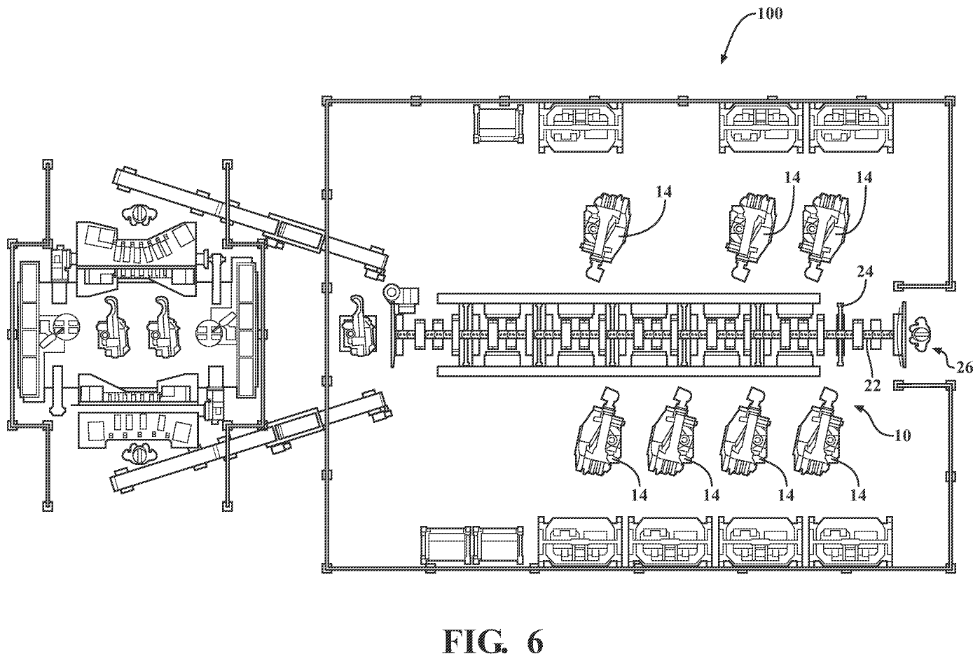

Referring generally to FIGS. 1-12, and more particularly to FIGS. 6-12, there is depicted the articulating modular trim system shown generally at 100, including a plurality of robots 14 each with EOAT 10 operably attached to the ends of the robots 14. By way of non-limiting example, a bank of at least eight robots with trim dies operably attached to them for processing extrusions 24 advanced through the system. Preferably, a conveying system 22, e.g., “walking beam”, belt, etc., carries each extrusion 24 that is going to be trimmed. Once the extrusion 24 moves into predetermined positions, the respective robot 14 then operably aligns the EOAT 10 and positions the die trim portions 12, preferably, the trim dies 34, onto the extrusion 24 to complete at least one of the predetermined operations, e.g., trim. Preferably, a plurality of holders is coupled to the walking beam 22 spaced apart to assist in selectively holding each extrusion 24.

It is understood that more or less robots 14 are used depending on the particular application without departure from the scope of the present invention. It is further understood that any suitable advancing and robotic operations and sequencing is contemplated depending on the application without departure from the scope of the present invention. Alternatively, a single cell is provided with a robot 14.

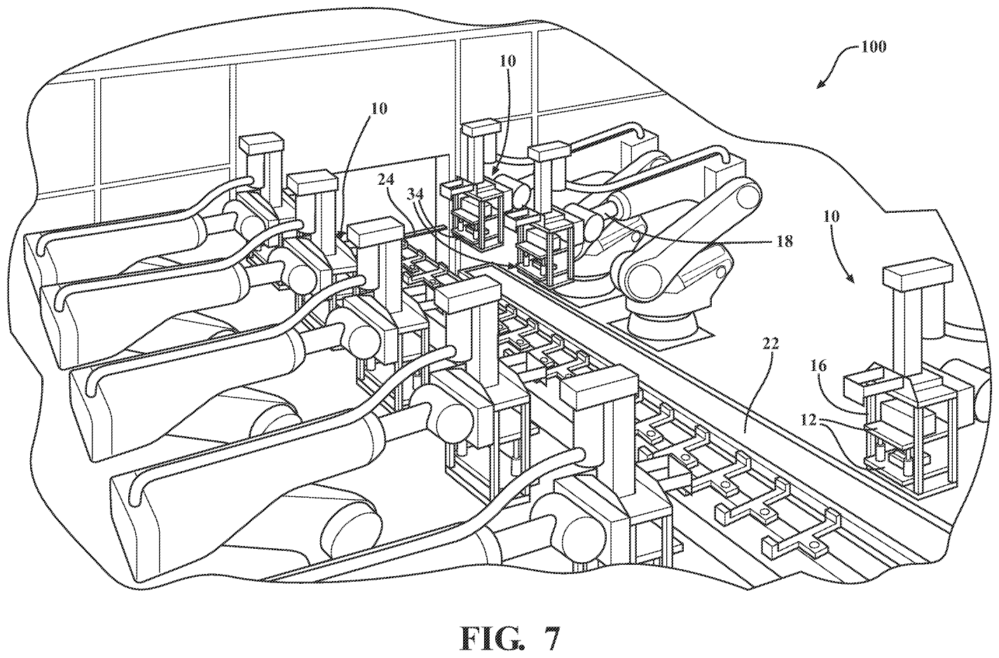

FIG. 7 illustrates the articulating modular trim system 100, in accordance with aspects of the present invention, with the conveyance system 22 provided to advance a plurality of parts 24 to the plurality of robots 14 positioned on at least one side of the system 22, the plurality of robots 14 each having EOAT 10 each with at least one trim die portion 12 with the die trim 34. Each robot 14 is a multi-axis robot with quick change capability.

An extrusion 24 entering the system via an operator station 26 (part load station) operably placed and held on the conveyance system 22 to selectively advance the parts to each predetermined robotic operation. The robotic system is programmable depending on the particular applications and the EOAT expeditiously able to be changed over as needed depending on the product. It is understood that, alternatively, parts can be pre-loaded and placement on the conveyance system 22 automated. The conveyance device 22 advances each extrusion 24 operably secured thereto.

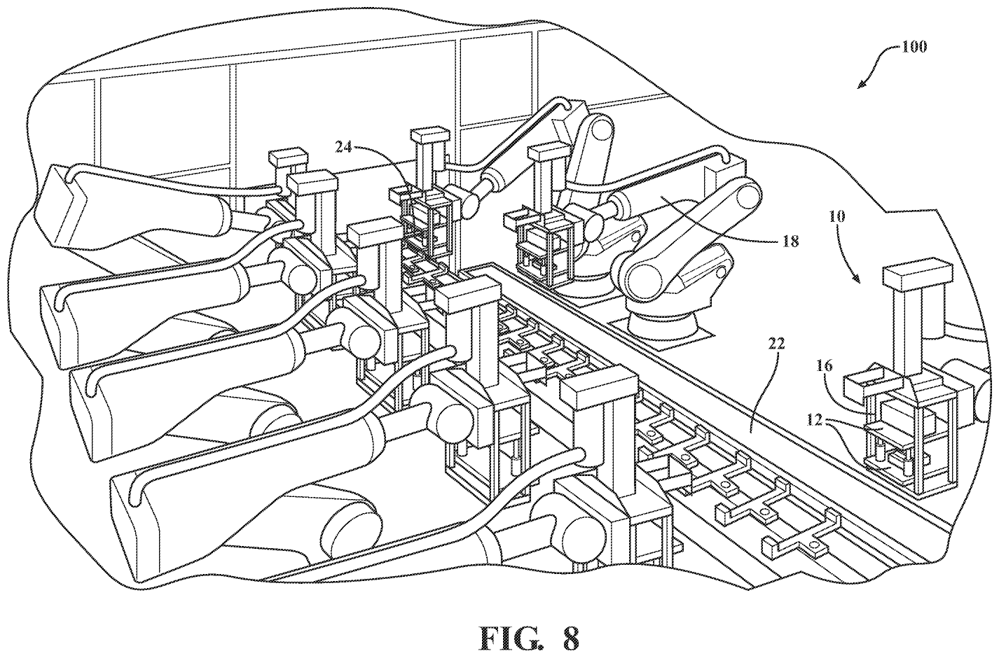

FIG. 8 depicts the first robot 14 moved into position relative to the extrusion 24 on the conveyance system 22 and then the trim die portion 12 on the end of arm 18 of the robot is moved (e.g., clamped, pressed, slide) onto the extrusion 24 to operably trim the extrusion 24 in at least one predetermined location, at predetermined press-force, for a predetermined period of time. Preferably, the EOAT 10 includes at least one bracket or block 36 operably connected to a surface, e.g., a top surface, of the trim die portion 12. The block 36 is operably coupled to an attachment feature 38, e.g., of a bore with a predetermined stroke, preferably, at least about 4 to 6 inch stroke, operable to selectively move at least the second portion 32 of the die press portion 12 in a first and a second direction (preferably, substantially up/down), thereby bringing predetermined die trim 34 features into contact with at least one predetermined location on the part 24 to perform a predetermined operation (e.g., into contact with at least one cutter to trim the extrusion 24). The dies are operably selectively activated, e.g., hydraulics to activate dies, more preferably, respective electric actuators.

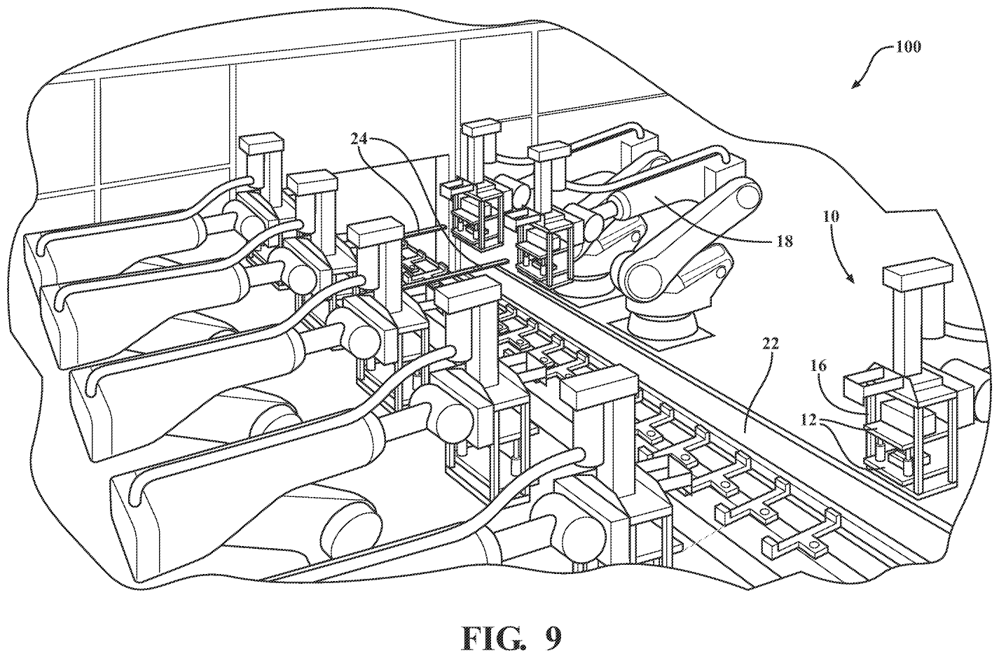

FIGS. 9-12 depict the extrusions 24 advancing further along the conveyance system 22 and additional robots 14 selectively operably bringing EOAT 10 trim die portions 12 into proximity with respective extrusions 24 at predetermined locations and performing predetermined trim operations or other predetermined operations.

The present invention provides significant advantages, including (but not limited to), variations in the extrusion cross sections are overcome by mounting the interchangeable trim tool on a multi-axis robot with quick change capability, the extrusion is operably held securely in position, and the present invention allows the ability to retool the automation easily.

It is understood that alternative trim die, EOAT, robot arms and robots are used depending on the application without departure from the scope of the present invention. It is understood that more or less robots are used depending on the application without departure from the scope of the present invention. While an extrusion is described, it is understood that any alternative part and material(s) is contemplated depending on the particular application without departure from the scope of the present invention.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An articulating modular trim system adapted to manufacture a part, comprising:
at least one conveyance system adapted to selectively advance a plurality of parts;
a plurality of robots operable for predetermined multi-axis movement and programmable to perform at least one predetermined operation;
a plurality of end of arm tooling operably connected to said plurality of robots, said end of arm tooling adapted to selectively perform said at least one predetermined operation to said plurality of parts;
a die holder of the end of arm tooling operable to couple a die for each end of arm tool operably mounted to each of the plurality of robots.

2. The articulating modular trim system of claim 1, wherein the die is a trim die.

3. The articulating modular trim system of claim 1, wherein the plurality of parts is each an extrusion.

4. The articulating modular trim system of claim 1, wherein the conveyance system is a walking beam adapted to selectively advance the plurality of parts relative to the plurality of robots.

5. The articulating modular trim system of claim 1, wherein the conveyance system is a walking beam and each of said plurality of parts is an extrusion operably loaded onto holders on said walking beam by an operator.

6. The articulating modular trim system of claim 1, further comprising an attachment portion on the end of arm tooling that allows interchangeability of the end of arm tooling depending on the parts being processed.

7. The articulating modular trim system of claim 1, wherein said at least one predetermined operation is selected from the group consisting of trimming, cutting, piercing, clipping, pressing, punching at least one aperture, forming at least one predetermined feature, punching at least one predetermined shape, and combinations thereof.

8. The articulating modular trim system of claim 1, wherein the end of arm tooling further comprises a die portion operably connected to the die, wherein said die portion operably articulates in a first direction when one of said plurality of extrusions is within said die portion to perform said predetermined operation, and in a second direction after said predetermined operation is completed.

9. The articulating modular trim system of claim 1, said die holder is operably coupled to a die trim portion operably adapted to perform said predetermined operation on said plurality of parts

10. The articulating modular trim system of claim 1, further comprising a plurality of trim dies operably mounted to a robotic arm end on each of said plurality of robots using specifically designed said plurality of die holders.

11. The articulating modular trim system of claim 1, further comprising at least one attachment portion to operably connect said plurality of end of arm tools to said plurality of robots, wherein said end of arm tooling is an interchangeable tool in order to process different shaped parts.

12. The articulating modular trim system of claim 1, wherein said plurality of parts are extrusions, and wherein variations in the extrusion cross sections are accommodated by the multi-axis movement of each robot as needed in response to any cross section variations.

13. The articulating modular trim system of claim 1, comprising at least one of said plurality of robots on each side of said conveyance system.

14. An articulating modular trim die system adapted to manufacture a vehicle
part, comprising:
at least one conveyance system adapted to selectively advance a plurality of parts;
at least one robot operable for predetermined multi-axis movement and programmable to perform at least one predetermined operation;
at least one end of arm tool operably mounted to a robot arm of said at least one robot, each of said at least one end of arm tool operably coupled to a trim die, said at least one end of arm adapted to selectively perform said at least one predetermined operation sequentionally to said plurality of parts; and
a die holder of said at least one end of arm including at least one attachment portion, said die holder operably coupled to said trim die and operably mounted to said at least one robot with said at least one attachment portion.

15. An articulating modular trim die system of claim 14, wherein said conveyance system is a walking beam and each of said plurality of parts is an extrusion that is operably loaded onto holders on said walking beam to advance said plurality of parts adjacent to said at least one robot.

16. An articulating modular trim die system of claim 14, wherein said at least one end of arm tooling further comprises a trim die portion operably connected to said die trim, wherein said trim die portion operably articulates in a first direction when one of said plurality of part is within said die trim to perform said at least one predetermined operation, and in a second direction after said predetermined operation is completed for said at least one robot to move said end of arm tooling out of engagement with said part.

17. An articulating modular trim die system of claim 14, wherein said die trim cuts said plurality of parts at at least one predetermined location.

18. An articulating modular trim die system of claim 14, wherein said at least one robot is a plurality of robots located on both sides of said conveyance system, and wherein said at least one end of arm tooling is a plurality of end of arm tools that are selectively interchangeable on said plurality of robots depending on different plurality of parts.

19. An articulating modular trim die system of claim 14, wherein said plurality of parts are extrusions, and wherein variations in the extrusion cross sections are accommodated by the multi-axis movement of each robot as needed in response to any cross section variations and in combination with interchangeability of said trim dies.

20. An articulating modular robotic trim system adapted for manufacturing a vehicle extrusion, comprising:
providing an end of arm tool including a die holder operable to couple to a trim die portion;
providing at least one robot with a robot arm operably connected to the die holder;
providing a trim die operably mounted to the ends of the robots using the specifically designed die holder;
providing a conveying system adapted to selectively advance plurality of extrusions;
advancing the at least one extrusion on said conveying system into position with respect to said at least one robot;
moving the robot arm to position the trim die with respect to the extrusion;
performing at least one predetermined trim operation on the extrusion;
wherein the end of arm tooling is an interchangeable tool;
wherein the at least one robot is a multi-axis robot; and
wherein variations in the extrusion cross section are overcome by the mounting the end of arm tooling that is operably interchangeable on the at least one robot that is a multi-axis robot.
